(19) United States
(12) Patent Application Publication
(10) Pub. No.: US 2016/0347543 A1
(43) Pub. Date: Dec. 1, 2016

(54) METHOD AND APPARATUS FOR STORING AND RETRIEVING OR SHIFTING CONTAINERS IN HIGH-BAY WAREHOUSES

(71) Applicant: SMS LOGISTIKSYSTEME GMBH, Netphen (DE)

(72) Inventors: Carsten HEIDE, Netphen (DE); Volker BRUECK, Mudersbach (DE); Michél BANNERT, Siegen (DE)

(21) Appl. No.: 15/100,530

(22) PCT Filed: Jan. 19, 2015
(86) PCT No.: PCT/EP2015/050871

§ 371 Date: Jun. 2, 2016

(30) Foreign Application Priority Data
Feb. 19, 2014 (DE) 10 2014 203 006.4

(51) Int. Cl. B65G 1/04; B66C 1/10; B66C 19/00; B65G 63/00

(52) U.S. Cl. CPC B65G 1/0435; B65G 63/004; B66C 1/101; B66C 19/002

(57) ABSTRACT

A method for storing and retrieving or shifting containers (4, 34) in high-bay warehouses (1) of a transfer facility, in particular of a sea port or inland port, wherein the containers (4, 34) are transported, and stored and retrieved or shifted, by storage-and-retrieval units (7) which can be displaced in aisles (6) extending parallel to compartments (3) of the high-bay warehouse (1), said compartments being arranged on a number of levels in storage modules (2). The intention is to create, for such a high-bay warehouse (1), a method and an apparatus which reduce usage of transporting means and, with the high-hay warehouse (1) being of narrow construction, make it possible for any individual container (4, 34) to be accessed even by floor-going stackers (7). For this purpose, raisable and lowerable telescopic holders (35 to 38; 40, 41) of the storage-and-retrieval unit (7) are used to store the containers (4, 34) telescopically, with their longitudinal sides (11) in front, in the compartments (3) from a transporting position, in which said containers preferably do not project beyond the peripheral outer contour of the storage-and-retrieval unit (7), and to remove them therefrom and telescope them back into the transporting position in the storage-and-retrieval unit (7).

The invention relates to a method and apparatus for storing, retrieving, or moving containers in tall rack storage systems of a transfer facility, more particularly a sea port or an inland port where the containers are moved about as well as stored and retrieved and moved by storage and retrieval units that can travel in aisles extending parallel to compartments of the tall-rack storage system that are on a number of levels in storage units.

Known through EP 1 272 414 [US 2003/0047529] is a transfer facility at a sea port and inland port for, in particular, standard containers such as 20 TEU or 40 TEU containers, with a container storage rack of individual row-like storage modules provided along a quay and with at least one loading apparatus interacting with the storage modules for transferring cargoes from and to a ship moored at the quay. The loading apparatus for transferring cargoes is equipped with at least one mobile port crane. Its cargo jib extends to the transfer area of the least one container storage rack comprising a number storage modules provided with container rows dependent on the module width, forming an interface between the port mobile crane and the storage modules of the container store.

A container placed on the transfer area by the pivoting jib of the mobile port crane is grasped by a stacking crane that carries out the horizontal transportation and stacking of the containers. The stacking crane is designed as an upright gantry crane with crane trolley and spans a storage module, for example nine containers wide and three to four containers high, of the container storage rack extending at right angles to the quay. The storage modules are interlinked by at least two independently acting lateral transporters moving in different horizontal planes perpendicular to the individual storage modules. The containers are stacked on top of each other in the compartments of the storage modules of the container store, which prevents effective storage and retrieval.

From DE 10 2008 007 860 it is known to storage rack and retrieve any number of containers on top of or next to each other individually in compartments, thereby making moving of the containers in any sequence possible. For this, in view of the limited area available in port terminals, and to avoid their expansion, portal cranes are used that allow more closely spaced storage of the containers than in the aisles used by floor-going stackers or storage and retrieval units. The containers are arranged with a slight space on top of each other and individually accessible in the compartments that in the direction of the interior of the compartment are equipped with rails on both sides corresponding to the width of the container place with their front end in the compartment. The gantry crane that can travel over the aisles carries a container grab that can be raised and lowered by cables that is arranged on a transfer bridge equipped with rails and at its ends has motor or hydraulically height-adjustable container grips that can be locked on suspension points of the containers at the corners, wherein the containers can be placed on transverse beams arranged in the compartment and/or picked up from them. For the storage and retrieving of containers, the container grabs are traveled over on alternate sides over driven rollers on the tracks of the compartments in their longitudinal direction over the entire compartment depth. For adaptation to the different container lengths the container grab has length-adjustable transverse beams on which the container grips are provided.

The object of the invention is to provide a method and a device with which in multilevel storage racks of this type transport use can be reduced and access to every individual container can also be achieved with floor-going stackers in a narrowly structure multilevel storage unit.

This object is attained in accordance with the invention through a method that is characterized in that through raisable and lowerable telescopic grabs of the storage and retrieval unit the containers, with their longitudinal sides outward are preferably telescopically stored in the compartments without projecting beyond the footprint or removed from them and telescopically moved back into the transfer position in the storage and retrieval unit.

During this the container are preferably brought suspended by the extended telescopic grabs, out of the contour of the storage and retrieval devices, into the compartments and advantageously only placed there supported on their corners. On retrieval from the compartment the containers are again preferably suspended and through retraction of the telescopic grabs brought into their retracted starting position in the transfer position flush with the contour of the storage and retrieval unit, i.e. with their narrow ends sides pointing in the direction of the aisles.

A great advantage of this method of storing and retrieving containers is that longitudinal side storing and retrieval in interaction with the extension and retraction of the telescopic grabs with the containers suspended thereon in bursts, allows an extremely space saving design of the multilevel storage rack with the smallest possible width dimensions of the aisles. These only have to be slightly wider than the width of the container in order through sufficient lateral intermediate space to ensure traveling past the storage modules with the compartments. The storage and retrieval units can therefore be compact and require no additional space-occupying projecting jib or gripper arm for storing and or retrieving or stacking or moving. The broadest contour of the storage and retrieval unit largely corresponds to the container width without an overhang. Right from the start of the handling movement the when telescoping the telescopic grabs enter into the compartment with the container with increasing horizontal displacement until the final storage position is reached.

Advantageously the method is characterized in such a way through a storage process that

at the introduction end of the multilevel storage rack the containers are made available with their longitudinal axis extending parallel to the multilevel storage rack on a side next to the aisles

subsequently a storage and retrieval device that is displaceable in the aisle is moved to outward of the container to be retrieved and picks up the locked container via its suspension point, for which, through a handling movement orthogonal to the aisle, telescoping grabs equipped with locking means are extended out of the storage and retrieval unit up to above the container suspension point and lowered for locking,

after locking, the telescopic grabs with the suspended containers are raised and through an opposite handling movement are retracted into the storage and retrieval unit until the container assumes a suspended position or transfer position in the compartment in a plane flush with the aisle.

subsequently the storage and retrieval unit is displaced in the aisle to a compartment to be filled and the telescopic grabs that are preferably arranged on a lifting bridge, are raised vertically if the compartment is at a higher level,

the container pre-positioned in this way is introduced into the compartment by a handling movement of the telescopic grab orthogonally the aisle,

the container is then placed with its container corner area on the corner supports arranged on the vertical posts of the storage module defining the compartments and

after releasing the container the telescopic grabs are raised and moved back into their retracted starting position.

During the retrieval or moving of a container e.g. changing the storage position within a storage module or into a different aisle, e.g. in order to improve throughput, wherein the telescopic grabs are moved out of the storage and retrieval unit into their holding position in the compartment, the fully automatically handling and travel as well as locking movements are the reverse of the storage procedure described above.

A device according to the invention, more particularly for implementing the method envisages that the multilevel storage rack for the longitudinal side storage of containers consist of any number of storage units of a depth corresponding to a container width, on multiple levels several compartments high, which are consecutively arranged in rows in the longitudinal direction along one aisle side and are each separated in the transverse direction by one aisle, and has storage and retrieval units that can be moved back and forth in the aisles and are designed with telescopic grabs that can be extended or retracted orthogonally to the aisle and can be raised and lowered for holding a container. The containers intended for storing in the compartment of the storage modules are provided by transporters and/or intermediate transfer means, e.g. slides that after depositing of the containers by the transport vehicle, moves them to the access area of the storage and retrieval unit, at a front side of the multilevel storage next to the aisles where they are picked up by the storage and retrieval devices and transported to a compartment with their narrow ends facing in the direction of the aisle.

Containers intended for retrieval from a compartment are moved by the storage and retrieval unit with their longitudinal sides outward horizontally from the compartment into the contour of the storage and retrieval unit and are then transported with their narrow end facing in the direction of the aisle directly to the end of the multilevel storage rack opposite the storage end and are made ready for transporting away. It should be noted here that the material flow has all degrees of freedom and that a static allocation of the ends is not stipulated, so that storing and retrieving procedures can take place from both ends of the multilevel storage unit.

The containers that during storing are moved horizontally with their longitudinal sides outward out of the contour of the storage and retrieval unit into the compartment, are there placed, by a lifting movement of the storage and retrieval unit, with their base corner sections on corner supports provided therefore in the compartments.

With the storage and retrieval units that preferably can enter the aisles from both ends of the multilevel storage unit, any kind of access to every single container stored in the containers of the multiple-level storage modules is possible.

In one embodiment of the invention, the floor/aisle-bound storage and retrieval unit comprises a frame, comprising vertical posts and head or foot beams connecting them to each other, which is of a height corresponding to the multiple-level multilevel storage unit.

For moving the storage and retrieval device a drive is advantageously integrated into the foot beams and is implemented by a wheel/rail connection usual in storage and retrieval units.

A preferred embodiment of the invention envisages that a hoisting device runs in guides of the vertical posts and comprises side supports consisting of spaced, parallel longitudinal beams opening upward in a forked or y-shaped manner and these on both opposite fork ends connect with each other to form a frame, wherein to reinforce the hoisting device parallel struts are provided under the longitudinal beams that each extend from one foot end of one side support to the foot end of the other side support. The hoisting device formed in this way that due to its structure combining the two side supports can also be called a hoisting bridge always remains in the axis of the storage and retrieval unit during all required handling movements.

In accordance with the invention, for raising/lowing the hoisting device/hoisting bridge, a cable control device, comprising a cable, a cable drum, pulleys, a hoist motor and hoist gears is provided, via which the hoisting device/hoisting bridge and be exactly horizontally positioned relative to a compartment at any level within the storage and retrieval unit.

The length of the hoisting device/hoisting bridge for picking up a container is designed in accordance with the largest occurring container length and the symmetrical width of the fork or y-shaped side supports in accordance with the standard container width, so that the largest outer dimensions of the hoisting device/hoisting bridge can be the same as the outer dimensions of the containers. Accordingly the multilevel storage rack can have storage locations for containers of different lengths and heights that are transported and maneuvered by the storage and retrieval units. The containers are, for example, standard containers corresponding to DIN-ISO-668 dimensions and ISO-6346 types.

A further embodiment of the invention envisages that arranged spaced from one another on the longitudinal beams of the hoisting device/hoisting bridge are two further stationary telescopic grabs the spacing between them bridging the smallest container length and, two further stationary telescopic grabs spaced corresponding to the largest container length.

For storing or retrieving a standardized 20-foot container TEU (twenty-foot equivalent unit) the two inner telescopic grabs with the smallest distance between them are used, whereas for storing and retrieving a standardized 40-foot container FEU (forty-foot equivalent unit) the two outer telescopic grabs with the greatest distance between them are used. The stationary telescopic unit are fastened with their basic housing to the underside of the longitudinal beams, wherein the two inner telescopic grabs are arranged offset in height with regard to the outer telescopic grabs.

In accordance with a preferred embodiment of the invention it is envisaged that on inner sides of the longitudinal beams facing each other linear guides are arranged in which two telescopic grabs can be moved and through a movement can be positioned toward or away from each other in accordance with the length of the container in question. In this way, with only two telescopic grabs both 20-foot containers and also 40-foot containers or containers with other dimensions can be stored and retrieved or moved, for which, in accordance with one proposal of the invention, the displaceable telescopic grabs roll along the linear guides in the longitudinal beams on rollers arranged upright in holding or support blocks on their basis housings.

In accordance with the invention it is also envisaged that for each linear guide, two double roller arrangements are provided on each of the sides of the basis housing of the telescopic grabs. The thus resulting in total eight roller grab allows secure and warp-free movement of the telescopic grabs within the linear guides.

One advantageous embodiment of the invention envisages that both the basic housing of the stationary telescopic grabs and also the basic housing of the displaceable telescopic grabs accommodates two extendable and retractable telescopic pusher arms, wherein an outer telescopic pusher arm runs with bilateral outer guide profiles on rollers of the basic housing and an inner telescopic pusher arm runs with bilaterally arranged rollers in inner guide profiles of the outer telescopic pusher arm.

The telescopic pusher arms are integrated in the basic housing in this way and are preferably displaceable by rack and pinion gearing, allow the telescopic grabs to be designed in a compact manner, so that neither the main housing nor the telescopic pushing arms when fully retracted in the basic setting project beyond the width of the hoisting device/hoisting bridge.

Additionally, seen in the direction of the longitudinal storage of the containers, the telescopic arms have front locking means arranged on the inner telescopic pushing arm, and rear locking means arranged on the outer telescopic pushing arm. The locking means consist of so-called twistlock bolts that are standardized and engage in complementary openings on the upper side of the container.

It can also be envisaged that on the narrow side of a vertical post of the storage and retrieval unit a stage structure, attached to the vertical post and the foot beam, is arranged for accommodating supply means for the hoisting device, the drive of the storage and retrieval unit and the displaceable telescopic grabs. The stage structure serves as a platform for, for example, switch and electrical boxes, cable drums, hoist motor and hoist gears as well as brakes and braking resistors, wherein the width of the stage structure is approximately identical to the width of the hoist device and the storage and retrieval unit.

Further features and details of the invention are set out in the claims and following description of examples of embodiment of the invention shown in the drawing. In these

FIG. 1 is a perspective, simplified overall view of a multilevel storage rack with floor-based storage and retrieval units that are displaceable in the aisles;

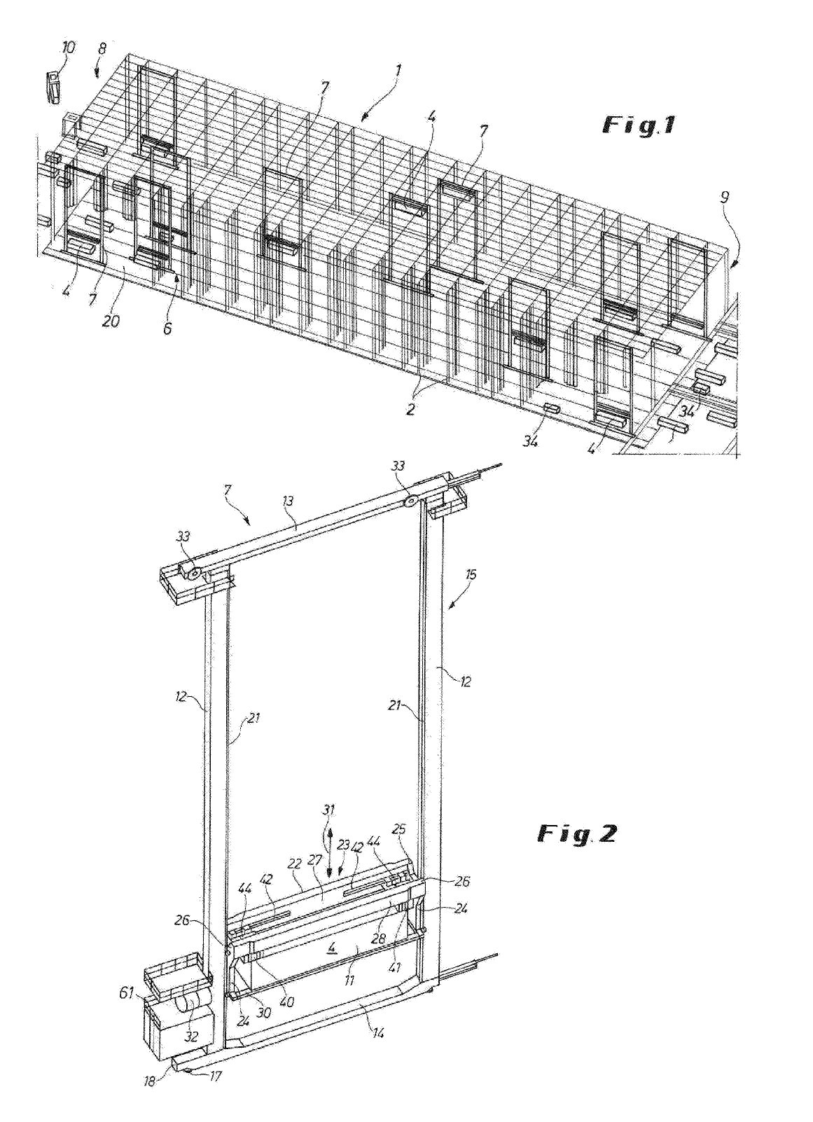

FIG. 2 is a perspective overall detail view of a storage and retrieval unit,

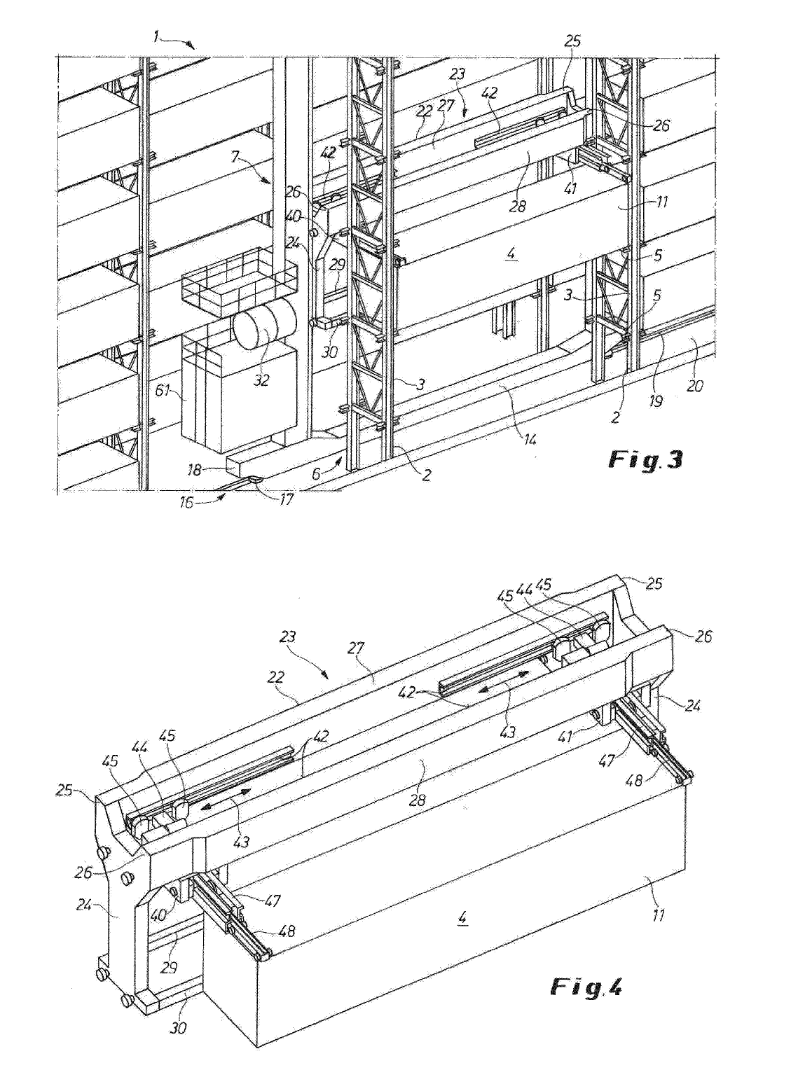

FIG. 3 is a perspective partial view of a detail of the multilevel storage rack in FIG. 1 with a storage and retrieval unit standing outward of a compartment of a storage module with telescopic grabs for inserting a container into the compartment,

FIG. 4 is a perspective partial view of a detail of the storage and retrieval unit in FIG. 3 with its hoisting bridge with a container suspended on the extended telescopic grabs,

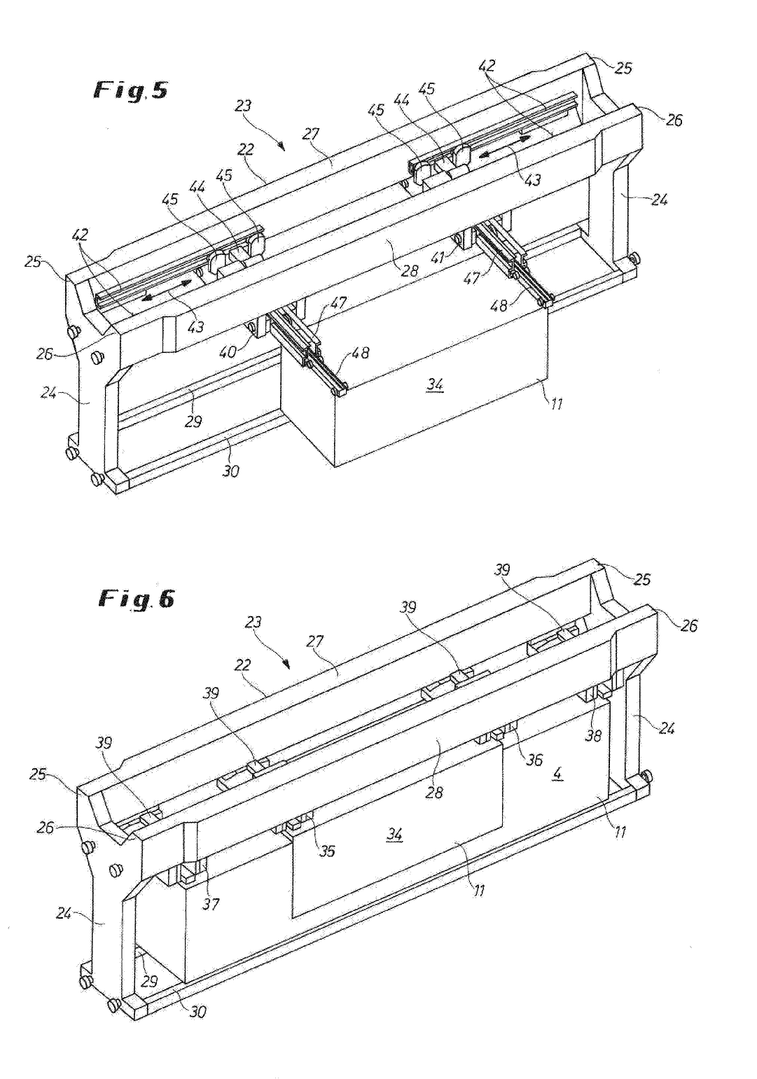

FIG. 5 is a detail view like FIGS. 3 and 4 showing the hoisting bridge of the storage and retrieval unit with in this case, compared with FIG. 4, a container with smaller longitudinal dimension suspended and locked by the telescopic grabs, for which the telescopic grabs have been moved toward each other in linear guides of the longitudinal beams of the hoisting bridge,

FIG. 6 is a perspective view like FIGS. 4 and 5 of a hoisting bridge with telescopic grabs fastened in a stationary manner on longitudinal beams of the hoisting bridge of longitudinal dimensions corresponding to the smallest container and the largest container that from the start are arranged so that they can be locked on suspension points of the container,

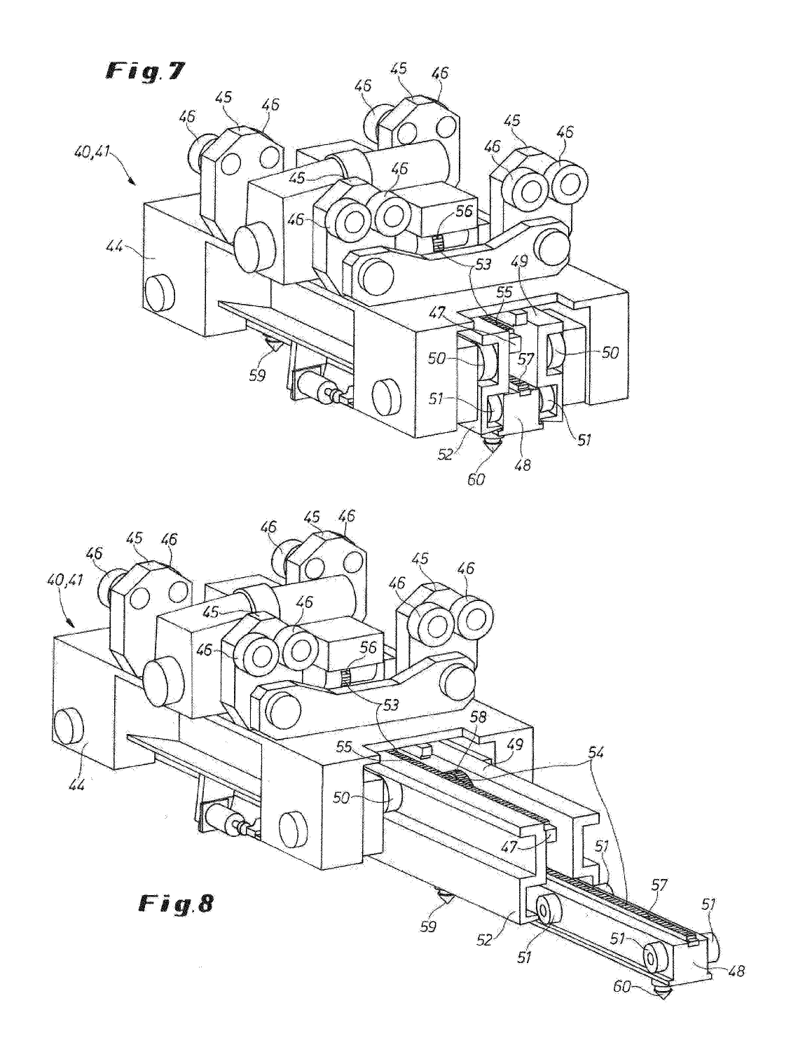

FIG. 7 is a perspective detail view of a telescopic grab in the starting position with retracted telescopic pusher arms, and

FIG. 8 shows the telescopic grab of FIG. 7 with extended telescopic pusher arms.

FIG. 1 schematically shows a multilevel storage rack 1 comprising rows of storage modules 2 each with a vertical array of compartments 3 for storing and retrieving containers 4, the compartments 3 having corner supports 5 carrying the respective containers (see FIG. 3).

Between the storage module 2 are aisles 6 extending longitudinally along the entire length of the multilevel storage rack 1 and along which storage and retrieval units 7 can travel back and forth, the storage and retrieval units 7 being able to enter the aisle 6 from both ends 8 and 9 of the multilevel storage rack 1.

The containers 4 are fed to the front end 8—and/or optionally the rear end—of the multilevel storage rack 1 by transporters 10 and possibly intermediate transfer means (not shown) at a side next to the aisle 6 with their longitudinal axis extending parallel to the multilevel storage unit. There the containers 4 are picked up in a suspended position by the storage and retrieval units 7 and transported along the aisles 6 to a compartment 3 of a storage module 2 into which they are placed with their longitudinal side 11 outward. In divergence from the illustrated embodiment and in dependence on the actual integration of the multilevel storage rack in a container terminal, storage and retrieval points, for example, can be located on the longitudinal sides of the multilevel storage unit.

A container retrieved from a compartment 3 by the storage and retrieval unit 7 for removal from the storage rack is transported via the aisle 6 to the rear end 9 of the multilevel storage rack 1 and deposited there for outbound transport.

The storage and retrieval unit 8 shown in detail in FIG. 2 has a frame 15 that comprises vertical posts 12 and, connecting them, head and foot beams 13, 14 and is the same height as a multiple level storage module 2.

The storage and retrieval unit 7 can be displaced via rack and pinion gearing 16, a drive toothed wheel 17 being integrated into an end 18 of the foot beam 14 and the rack 19 in which it engages is mounted in a base 20 of the aisle 6 as is indicated in FIG. 3.

The vertical posts 12 have guides 21 in which a hoisting bridge 22 of a hoisting device 23 that consists of lateral forks 24 widening out upward and, connecting them at two opposite fork ends 25 and 26 to form a frame, spaced longitudinal beams 27 and 28 extending parallel to each other. To reinforce the hoisting device 23 at the lower end of the support forks 24 and bridging them are spaced parallel foot beams 29 and 30 (see FIGS. 4, 5 and 6).

For raising and lowering the hoisting bridge 22 in accordance with double arrow 31 there is cable control device of which only the cable drum 32 and pulleys 33 on the head beam 13 of the storage and retrieval device 7 are shown.

The length of the hoisting bridge 22 the hoisting device 23 is designed for receiving the container 4 that has the largest occurring container length of, for example, 40 FEU (forty-foot equivalent unit). However, containers 34 that have the smallest occurring container length of, for example, 20 TEU (twenty-foot equivalent unit) should also be able to be held and transported by the hoisting device 23 (see FIGS. 5 and 6).

As shown in FIG. 6, the longitudinal beams 27 and 28 of the hoisting bridge carry two inner stationary inner telescopic grabs 35 and 36 for holding the shorter container 23 and two outer telescopic grabs 37 and 38 set further apart from one another for holding the longer container. The stationary telescopic grabs 35 to 38 have respective housings 39 secured to the undersides of the longitudinal beams 27 and 28, with the inner ones offset in height relative to the outer ones.

In accordance with a further embodiment shown in FIG. 5, only two telescopic grabs 40 and 41 are provided that can be displaced in linear guides 42 of the longitudinal beams 27 and 28 and can thus be positioned by movement toward or away from each other—double arrow 43—corresponding to the length of the container 34 or the container 4 (see FIGS. 2, 3 and 4). The displaceable telescopic grabs 40 and 41 are held in the linear guides 42 of the longitudinal beams 27 and 28 via double rollers 46 arranged on their housings 44 on supports 45 (see FIG. 7).

Both the basic housing 39 of the stationary telescopic grabs 35 to 38 and also the basic housing of the displaceable telescopic grabs 40 and 41 accommodate an outer telescopic pusher arm 47 and an inner telescopic pusher arm 48, wherein the outer telescopic pusher arm 47 runs with bilateral outer guide profiles 49 on rollers 50 of the basic housing 39 and 44, and the inner telescopic pusher arm 48 with bilaterally arranged rollers 51 in inner guide profiles 52 of the outer telescopic pusher arm 47 (see FIGS. 7 and 8).

The extension and retraction of the outer and the inner telescopic pusher arms 47 and 48 takes place via rack and pinion gearing 53 and 54. In the rack and pinion gearing 53 for the outer telescopic pusher arm 47 a rack 55 is provided between the outer guide profiles 49, while a pinion 56 meshing with the rack 55 is on the upper side of the basic housing 39 and 44. In the case of the rack and pinion gearing 54 for the inner telescopic pusher arm 48 a rack 57 is provided on the telescopic pusher arm 48 itself, and the pinion 58 engaging in the rack 57 is between the outer guide profiles 49 of the outer telescopic pusher arm 47.

For locking to the containers 4, 34 the telescopic pusher arms 47 are 48 are each fitted with so-called twistlock bolts on their underside.

The storage and retrieval unit 7 is also designed with a stage structure 61 arranged on the end section 18 of the foot beam 14. The stage structure 61 accommodates the equipment required for the drive 16 of the storage and retrieval unit 7 and for controlling the telescopic grabs 35 to 38 and 40, 41.

FIGS. 1 to 4 show the procedure for storing a container 4 in the multilevel storage rack 1.

With the outer and inner telescopic pusher arms 47, 48 fully retracted, the storage and retrieval unit 7 is moved by its rack and pinion gearing 16 in the aisle 6 to the front end 8 of the multilevel storage rack 1 in order to there pick up a container 4 provided at a side next to the aisle 6 with its longitudinal axis extending parallel to the multilevel storage rack 1. For this the telescopic grabs 40, 41 are displace via their double rollers 46 in the linear guides 42 in accordance with the length of the container 4 to be picked up and the outer and inner telescopic pusher arms 47, 48 are extended via their rack and pinion gearing 53, 54 over the container and lowered to over the container's suspension point. Through the front and rear twistlock bolts 59, 60 the container is now locked to the outer and inner telescopic pusher arm 47, 48.

After locking, the outer and inner telescopic pusher arms 47, 48 with the suspended container are lifted by the hoisting bridge 22 and via the rack and pinion gearing 53, 54 retracted into the storage and retrieval unit 7 or under the hoisting bridge 22 unit the container assumes a suspended or transfer position in the storage and retrieval unit 7 that is flush with the plane of the aisle 6.

Via its rack and pinion gearing the storage and retrieval device 7 is displaced in the aisle 6 to a compartment 3 to be occupied in a storage module 2 and the hoisting bridge 22 with the suspended container 4 is positioned for the horizontal, telescopic handling procedure. The container 4 can now through extension of the outer and inner telescopic pusher arms 47, 48 be telescoped with its longitudinal side 11 outward into the compartment 3 and placed there through lowering the hoisting bridge 22 on to the corner supports 5.

After loosening the locking of the container 4 through unlocking the twistlock bolts 59, 60, the outer and inner telescopic pusher arms 47, 48 are raised and via the rack and pinion gearing 53, 54 are moved into their retracted starting position under the hoisting bridge 22 so that the storage and retrieval unit 7 is ready for a new storage and/or retrieval procedure.

On retrieving a container 4, 34 from a compartment 3 of a storage module 2 by the storage and retrieval unit 8, wherein the container is then taken to the rear end section 9 of the multilevel storage rack 1, the fully automatically controlled drive, hoisting and telescoping and locking movements are the reverse of the storing procedure described above.

List of reference numerals

| | |
|---|---|
| 1 | Multilevel storage unit |
| 2 | Storage module |
| 3 | Compartment |
| 4 | Container (40 FEU) |
| 5 | Corner support |
| 6 | Aisle |
| 7 | Storage and retrieval unit |
| 8 | Front end section |
| 9 | Rear end section |
| 10 | Transport vehicle |
| 11 | Longitudinal side |
| 12 | Vertical post |
| 13 | Head beam |
| 14 | Foot beam |
| 15 | Frame |
| 16 | Rack and pinion gearing |
| 17 | Toothed wheel |
| 18 | End section |
| 19 | Rack |
| 20 | Base |
| 21 | Guide |
| 22 | Hoisting bridge |
| 23 | Hoisting device |
| 24 | Support fork |
| 25 | Fork end |
| 26 | Fork end |
| 27 | Longitudinal beam |
| 28 | Longitudinal beam |
| 29 | Foot strut |
| 30 | Foot strut |
| 31 | Double arrow |
| 32 | Cable drum |
| 33 | Pulley |
| 34 | Container (20 TEU) |
| 35 | Telescopic grab |
| 36 | Telescopic grab |
| 37 | Telescopic grab |
| 38 | Telescopic grab |
| 39 | Basic housing |
| 40 | Telescopic grab |
| 41 | Telescopic grab |
| 42 | Linear guide |
| 43 | Double arrow |
| 44 | Basic housing |
| 45 | Carrier/support |
| 46 | Double roller |
| 47 | Outer telescopic pusher arm |
| 48 | Inner telescopic pusher arm |
| 49 | Outer guide profile |
| 50 | Roller |
| 51 | Roller |
| 52 | Inner guide profile |
| 53 | Rack gearing |
| 54 | Rack gearing |
| 55 | Rack |
| 56 | Pinion |
| 57 | Rack |
| 58 | Pinion |
| 59 | Twistlock bolt |
| 60 | Twistlock bolt |
| 61 | Stage structure |

1. A method of storing, retrieving, or moving containers in multilevel storage racks of a transfer facility, where the containers are moved about as well as stored, retrieved or displaced by storage and retrieval units that can travel in aisles extending parallel to respective rows of compartments of storage units of the multilevel storage racks
telescopingly extending the grabs and inserting the containers with raisable and lowerable telescopic grabs of the storage and retrieval unit into and telescoping retracting the grabs and removing the containers from the compartments (3) with their longitudinal sides outward through a transfer position not projecting beyond a footprint of the storage rack and retrieval unit.

2. The method according to claim 1, wherein
the containers are suspended from the telescopic grabs for storing and/or retrieving.

3. The method according to claim 1 wherein
the containers are stored in the compartments only supported at their corners.

4. The method according to claim 1, wherein a one of the containers is inserted into a one of the compartments by the steps of sequentially:
feeding at an entrance end of the multilevel storage rack the one container in with its longitudinal axis extending parallel to the multilevel storage rack on a side next to the respective aisle,
moving a storage and retrieval unit that can travel in the aisle to outward of the one container and then picking up the one container by locking the unit to suspension points of the container into a suspended position by an extension movement orthogonal to the aisle of the telescopic grabs equipped with locking means from the storage and retrieval unit to above the container suspension point and a lowering movement thereonto,
after locking, raising the telescopic grabs with the suspended container and via an inverse handling movement retracting the telescopic grabs with the suspended container back into the storage and retrieval unit until the container is suspended in the transfer position in the storage and retrieval unit flush with the plane of the aisle,
displacing the storage and retrieval unit along the aisle to outward of the compartment to be occupied, and raising the telescopic grabs vertically if the compartment is on a higher level,
inserting the container pre-positioned in this way into the one compartment through a handling movement of the telescopic grabs orthogonal to the aisle,
setting the container with its container corners on the corner supports on vertical posts of the storage module delimiting the compartments and
after unlocking of the container, raising the telescopic grabs and moving the telescopic grabs back into their retracted starting position.

5. An apparatus for storing, retrieving, or moving containers in multilevel storage racks of a transfer facility, the containers being transported as well as stored, retrieved or moved by storage and retrieval units that can travel in aisles extending parallel to respective rows of compartments of storage units of the multilevel storage rack, the multilevel storage rack (1) for the longitudinal side storage of containers (4, 34) having a plurality of storage units of a depth corresponding to a container width on multiple levels several compartments high that are consecutively arranged in rows in the longitudinal direction along one aisle side and are each separated in the transverse direction by one aisle the apparatus comprising:
storage and retrieval units that can move back forth in the aisles and that have raisable and lowerable telescopic grabs that can be extended and retracted orthogonally to the aisle for holding a container.

6. The apparatus according to claim 5, wherein
the storage and retrieval device has a frame that comprises vertical posts connected by head and foot beams and is of a height corresponding to the multiple level multilevel storage rack.

7. The apparatus according to claim 6, characterized by
a drive integrated into the foot beam for moving the storage and retrieval unit along the floor.

8. The apparatus according to any claim 5, further comprising:
a hoisting device running in guides of the vertical posts and having Y-shaped forks widening upward with spaced and parallel longitudinal beams connecting opposite fork ends to form a frame, and
for reinforcing the hoisting device below the longitudinal beams, spaced, parallel struts that each extend from a foot end of one support fork to the foot end of the other support fork.

9. The apparatus according to any claim 5, wherein raising and/or lowering of the hoisting device takes place via a cable control device comprising a cable, a cable drum, pulleys a hoist motor, and hoist gears.

10. The apparatus according to claim 5, wherein
the length of hoisting device holding a container is equal to the largest available container length and the symmetrical width of the support forks in accordance with standardized container width, so that the larger outer dimensions of the hoist device coincide with the outer dimensions of the containers.

11. The apparatus according to any claim 5, further comprising:
two stationary outer telescopic grabs spaced from each other corresponding to the largest container length, and
two further stationary inner telescopic grabs on the longitudinal beams of the hoisting device bridging the spacing between them in accordance with the smallest container length.

12. The apparatus according to claim 5, wherein
the stationary telescopic grabs have respective basic housing fastened to undersides of the longitudinal beams.

13. The apparatus according to claim 5, further comprising:
inner guides on the two facing inner sides of the longitudinal beams in which two telescopic grabs can be displaced and through a movement toward or away from each other can be positioned in accordance with the length of the relevant container.

14. The apparatus according to claim 13, further comprising:
linear guides of the longitudinal beams in which the displaceable telescopic grabs roll with rollers arranged upright in carrier/supports on their basic housings.

15. The apparatus according to claim 14, wherein
for each linear guide two of the rollers are provided on the sides of the basic housing.

16. The apparatus according to claim 5, wherein
both the basic housing of the stationary telescopic grabs as well as the basic housing of the displaceable telescopic grabs have retractable and extendable inner and outer telescopic pusher arms the outer telescopic pusher arms each running with bilateral outer guide profiles on rollers of the basic housing and the inner telescopic pusher arms running with laterally arranged roller in inner guide profiles of the outer telescopic pusher arm.

17. The apparatus according to claim 16, further comprising;
rack and pinion gears for moving the telescopic pusher arms.

18. The apparatus according to any claim 5, wherein
the telescopic pusher arms, seen in the direction of the longitudinal storing of the container have a front locking means arranged on the inner telescopic pusher arm and area locking means arranged on the outer telescopic pusher arm.
